(19) United States
(12) Patent Application Publication
(10) Pub. No.: US 2002/0194006 A1
(43) Pub. Date: Dec. 19, 2002

(54) Text to visual speech system and method incorporating facial emotions

(75) Inventor: Kiran Challapali, New City, NY (US)

Correspondence Address: Corporate Patent Counsel, Philips Electronics North America Corporation, 580 White Plains Road, Tarrytown, NY, 10591, US

(73) Assignee: Koninklijke Philips Electronics N.V.

(21) Appl. No.: 09/821,138

(22) Filed: Mar. 29, 2001

(51) Int. Cl. G10L 21/06

(52) U.S. Cl. 704/276

(57) ABSTRACT

A visual speech system for converting emoticons into facial expressions on a displayable animated facial image. The system comprises: (1) a data import system for receiving text data that includes at least one emoticon string, wherein the at least one emoticon string is associated with a predetermined facial expression; and (2) a text-to-animation system for generating a displayable animated face image that can simulate at least one facial movement corresponding to the predetermined facial expression. The system is preferably implemented remotely over a network, such as in an on-line chat environment.

### BACKGROUND OF THE INVENTION

1. Technical Field

The present invention relates to text to visual speech systems, and more particularly relates to a system and method for utilizing emoticons to generate emotions in a face image.

2. Related Art

With the advent of the internet and other networking environments, users at remote locations are able to communicate with each other in various forms such as via email and on-line chat (e.g., chat rooms). On-line chat is particularly useful in many situations since it allows users to communicate over a network in real-time by typing text messages back and forth to each other in a common message window. In order to make on-line chat discussions more personalized, “emoticons” are often typed in to infer emotions and/or facial expressions in the messages. Examples of commonly used emoticons include :-) for a smiley face, :-(for displeasure, ;-) for a wink, :-o for shock, :-<for sadness. (A more exhaustive list of emoticons can be found in the attached appendix.) Unfortunately, even with the widespread us of emoticons, on-line chat tends to be impersonal, and requires the user to manually read and interpret each message.

With the advent of high speed computing and broadband systems, more advanced forms of communication are coming on-line. One such example involves audio-visual speech synthesis systems, which deal with the automatic generation of voice and facial animation. Typical systems provide a computer generated face image having facial features (e.g., lips) that can be manipulated. The face image typically comprises a mesh model based face object that is animated along with spoken words to give the impression that the face image is speaking. Applications utilizing this technology can span from tools for the hearing impaired to spoken and multimodal agent-based user interfaces.

A major advantage of audio-visual speech synthesis systems is that a view of an animated face image can improve intelligibility of both natural and synthetic speech significantly, especially under degraded acoustic conditions. Moreover, because the face image is computer generated, it is possible to manipulate facial expressions to signal emotion, which can, among other things, add emphasis to the speech and support the interaction in a dialogue situation.

“Text to visual speech” systems utilize a keyboard or the like to enter text, then convert the text into a spoken message, and broadcast the spoken message along with an animated face image. One of the limitations of text to visual speech systems is that because the author of the message is simply typing in text, the output (i.e., the animated face and spoken message) lacks emotion and facial expressions. Accordingly, text to visual speech systems tend to provide a somewhat sterile form of person to person communication.

Accordingly, a need exists to provide an advanced on-line communication system in which emotions can be easily incorporated into a dialogue.

### SUMMARY OF THE INVENTION

The present invention addresses the above-mentioned problems by providing a visual speech system in which expressed emotions on an animated face can be created by inputting emoticon strings. In a first aspect, the invention provides a visual speech system, wherein the visual speech system comprises: a data import system for receiving text data that includes word strings and emoticon strings; and a text-to-animation system for generating a displayable animated face image that can reproduce facial movements corresponding to the received word strings and the received emoticon strings.

In a second aspect, the invention provides a program product stored on a recordable medium, which when executed provides a visual speech system, comprising: a data import system for receiving text data that includes word strings and emoticon strings; and a text-to-animation system for generating a displayable animated face image that can reproduce facial movements corresponding to the received word strings and the received emoticon strings.

In a third aspect, the invention provides an online chat system having visual speech capabilities, comprising: (1) a first networked client having: (a) a first data import system for receiving text data that includes word strings and emoticon strings, and (b) a data export system for sending the text data to a network; and (2) a second networked client having: (a) a second data import system for receiving the text data from the network, and (b) a text-to-animation system for generating a displayable animated face image that reproduces facial movements corresponding to the received word strings and the received emoticon strings contained in the text data.

In a fourth aspect, the invention provides a method of performing visual speech on a system having a displayable animated face image, comprising the steps of: entering text data into a keyboard, wherein the text data includes word strings and emoticon strings; converting the word strings to audio speech; converting the word strings to mouth movements on the displayable animated face image, such that the mouth movements correspond with the audio speech; converting the emoticon strings to facial movements on the displayable animated face image, such that the facial movements correspond with expressed emotions associated with the entered emoticon strings; and displaying the animated face image along with a broadcast of the audio speech.

In a fifth aspect, the invention provides a visual speech system, comprising: a data import system for receiving text data that includes at least one emoticon string, wherein the at least one emoticon string is associate with a predetermined facial expression; and a text-to-animation system for generating a displayable animated face image that can simulate facial movements corresponding to the predetermined facial expression.

### BRIEF DESCRIPTION OF THE DRAWINGS

The preferred exemplary embodiment of the present invention will hereinafter be described in conjunction with the appended drawings, where like designations denote like elements, and:

FIG. 1 depicts a block diagram of a visual speech system in accordance with a preferred embodiment of the present invention; and

FIGS. 2 and 3 depict exemplary animated face images of the present invention.

### DETAILED DESCRIPTION OF THE INVENTION

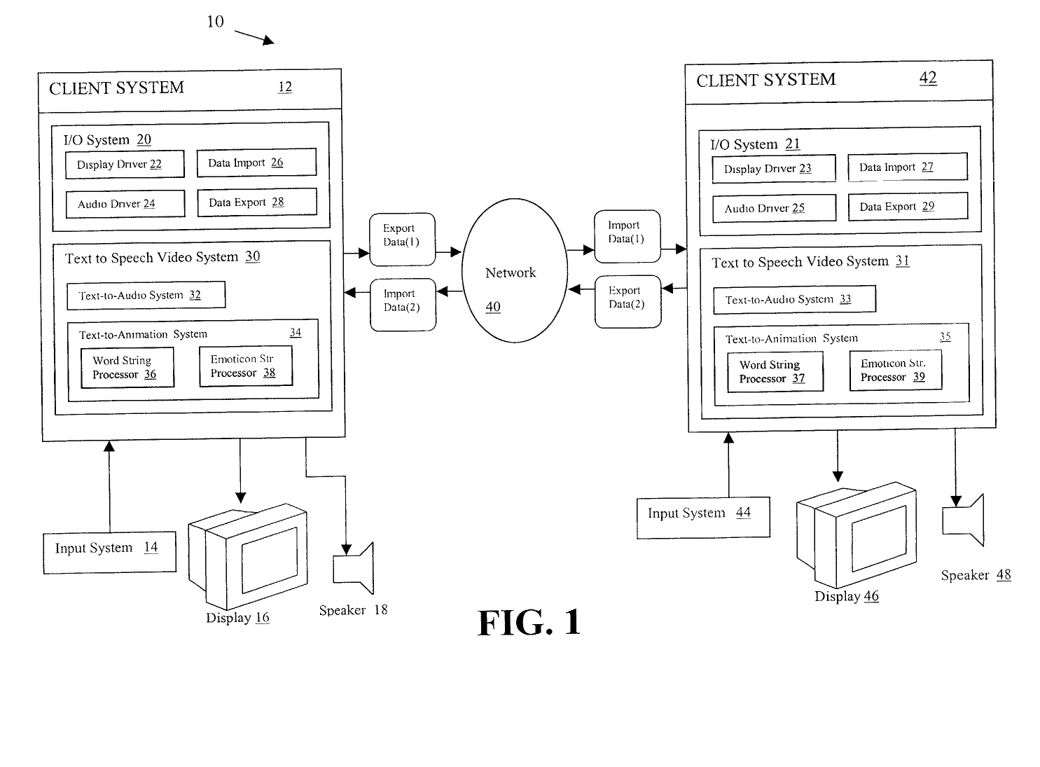

Referring now to FIG. 1, a visual speech system 10 is depicted. In the depicted embodiment, visual speech system 10 comprises a first client system 12 and a second client system 42 in communication with each other via network 40. It should be understood that while this embodiment is shown implemented on multiple client systems, the invention can be implemented on a single computer system that may or may not be connected to a network. However, a multiple client system as shown in FIG. 1 is particularly useful in online chat applications where a user at a first client system 12 is in communication with a user at a second client system 42.

Each client system (e.g., client system 12) may be implemented by any type of computer system containing or having access to components such as memory, a processor, input/output, etc. The computer components may reside at a single physical location, or be distributed across a plurality of physical systems in various forms (e.g., a client and server). Accordingly, client system 12 may be comprised of a stand-alone personal computer capable of executing a computer program, a browser program having access to applications available via a server, a dumb terminal in communication with a server, etc.

Stored on each client system (or accessible to each client system) are executable processes that include an I/O system 20 and a text to speech video system 30. I/O system 20 and text to speech video system 30 may be implemented as software programs, executable on a processing unit. Each client system also includes: (1) an input system 14, such as a keyboard, mouse, hand held device, cell phone, voice recognition system, etc., for entering text data; and (2) an audio-visual output system comprised of, for example, a CRT display 16 and audio speaker 18.

An exemplary operation of visual speech system 10 is described as follows. In an on-line chat application between users at client systems 12 and 42, a first user at client system 12 can input text data via input system 14, and a corresponding animated face image and accompanying audio speech will be generated and appear on display 46 and speaker 48 of client system 42. Similarly, a second user at client system 42 can respond by inputting text data via input system 44, and a second corresponding animated face image and accompanying audio speech will be generated and appear on display 16 and speaker 18 of client system 12. Thus, the inputted text data is converted into a remote audio-visual broadcast comprised of a moving animated face image that simulates speech. Therefore, rather than just receiving a text message, a user will receive a video speech broadcast containing the message.

In order to make the system more robust however, the user sending the message can not only input words, but also input emoticon strings that will cause the animated image being displayed to incorporate facial expressions and emotions. (For the purposes of this disclosure, the terms “facial expression” and “emotions” are used interchangeably, and may include any type of non-verbal facial movement). For example, if the user at client system 12 wanted to indicate pleasure or happiness along with the inputted word strings, the user could also type in an appropriate emoticon string i.e., a smiley face, :-). The resulting animated image on display 46 would then smile while speaking the words inputted at the first client system. Other emotions may include a wink, sad face, laugh, surprise, etc.

Provided in the attached appendix is a relatively exhaustive list of emoticons regularly used in chat rooms, email, and other forms of online communication to indicate an emotion or the like. Each of these emoticons, as well as others not listed therein, may have an associated facial response that could be incorporated into a displayable animated face image. The facial expression and/or emotional response could appear after or before any spoken words, or preferably, be morphed into and along with the spoken words to provide a smooth transition for each message.

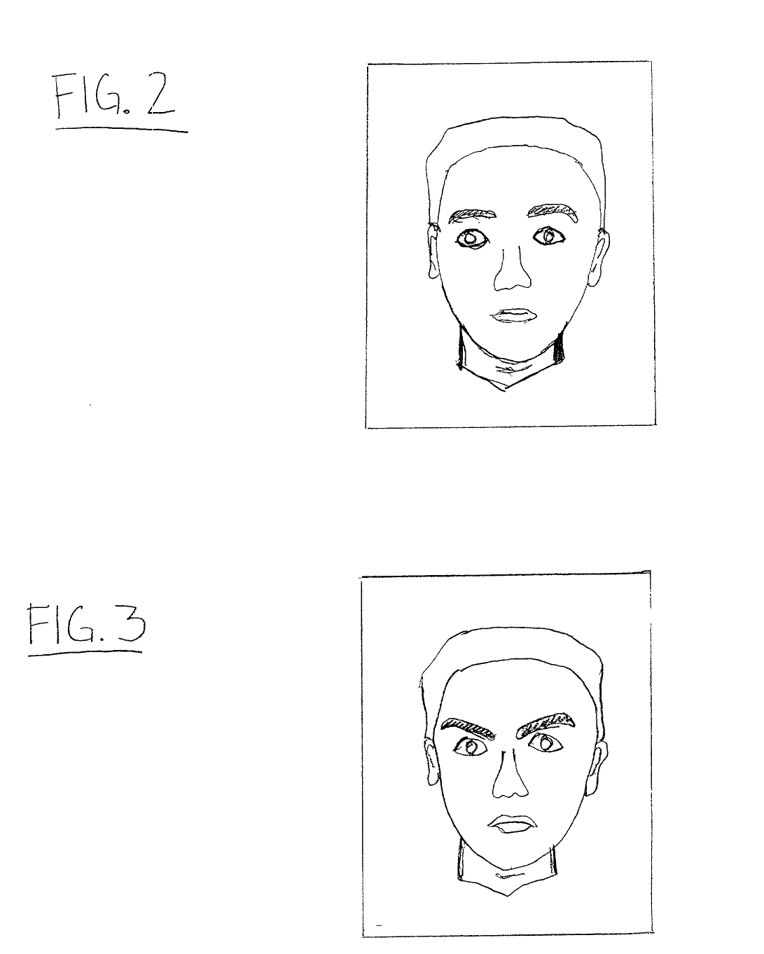

FIGS. 2 and 3 depict two examples of a displayable animated face image having different emotional or facial expressions. In FIG. 2, the subject is depicted with a neutral facial expression (no inputted emoticon), while FIG. 3 depicts the subject with an angry facial expression (resulting from an angry emoticon string >:-<). Although not shown in FIGS. 2 and 3, it should be understood that the animated face image may morph talking along with the display of emotion.

The animated face images of FIGS. 2 and 3 may comprise face geometries that are modeled as triangular-mesh-based 3D objects. Image or photometry data may or may not be superimposed on the geometry to obtain a face image. In order to implement facial movements to simulate expressions and emotions, the face image may be handled as an object that is divided into a plurality of action units, such as eyebrows, eyes, mouth, etc. Corresponding to each emoticon, one or more of the action units can be simulated according to a predetermined combination and degree.

Returning now to FIG. 1, the operation of the visual speech system 10 is described in further detail. First, text data is entered into a first client system 12 via input system 14. As noted, the text data may comprise both word strings and emoticon strings. The data is received by data import system 26 of I/O system 20. At this point, the text data may be processed for display at display 16 of client system 12 (i.e. locally), and/or passed along to client system 42 for remote display. In the case of an online chat, for example, the text data would be passed along network 40 to client system 42, where it would be processed and outputted as audio-visual speech. Client system 12 may send the text data using data export system 28, which would export the data to network 40. Client system 42 could then import the data using data import system 27. The imported text data could then be passed along to text-to-speech video system 31 for processing.

Text-to-speech video system 31 has two primary functions: first, to convert the text data into audio speech; and second, to convert the text data into action units that correspond to displayable facial movements. Conversion of the text data to speech is handled by text-to-audio system 33. Systems for converting text to speech are well known in the art. The process of converting text data to facial movements is handled by text-to-animation system 35. Text-to-animation system 35 has two components, word string processor 37 and emoticon string processor 39. Word string processor 37 is primarily responsible for mouth movements associated with word strings that will be broadcast as spoken words. Accordingly, word string processor 37 primarily controls the facial action unit comprised of the mouth in the displayable facial image.

Emoticon string processor 39 is responsible for processing the received emoticon strings and converting them to corresponding facial expressions. Accordingly, emoticon string processor 39 is responsible for controlling all of the facial action units in order to achieve the appropriate facial response. It should be understood that any type, combination and degree of facial movement be utilized to create a desired expression.

Text-to-animation system 35 thus creates a complete animated facial image comprised of both mouth movements for speech and assorted facial movements for expressions. Accompanying the animated facial image is the speech associated with the word strings. A display driver 23 and audio driver 25 can be utilized to generate the audio and visual information on display 46 and speaker 48.

As can be seen, each client system may include essentially the same software for communicating and generating visual speech. Accordingly, when client system 42 communicates responsive message back to client system 12, the same processing steps as those described above are implemented on client system 12 by I/O system 20 and text to speech video system 30.

It is understood that the systems, functions, mechanisms, and modules described herein can be implemented in hardware, software, or a combination of hardware and software. They may be implemented by any type of computer system or other apparatus adapted for carrying oat the methods described herein. A typical combination of hardware and software could be a general-purpose computer system with a computer program that, when loaded and executed, controls the computer system such that it carries out the methods described herein. Alternatively, a specific use computer, containing specialized hardware for carrying out one or more of the functional tasks of the invention could be utilized. The present invention can also be embedded in a computer program product, which comprises all the features enabling the implementation of the methods and functions described herein, and which—when loaded in a computer system—is able to carry out these methods and functions. Computer program, software program, program, program product, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the preferred embodiments of the invention have been presented for purposes of illustration and description. They are not intended to be exhaustive or to limit the invention to the precise form disclosed, and obviously many modifications and variations are possible in light of the above teachings. Such modifications and variations that are apparent to a person skilled in the art are intended to be included within the scope of this invention as defined by the accompanying claims.

APPENDIX

| | |
|---|---|
| #:-o | Shocked |
| %-( | Confused |
| %-) | Dazed or silly |
| >>:-<< | Furious |
| >-> | Winking devil |
| >-< | Furious |
| >-) | Devilish wink |
| >:) | Little devil |
| >:-> | Very mischievous devil |
| >:-< | Angry |
| >:-< | Mad |
| >:-( | Annoyed |
| >:-) | Mischievous devil |
| >=\hat{ } P | Yuck |
| <:> | Devilish expression |
| <:-> | Devilish expression |
| <:-( | Dunce |
| <:-) | Innocently asking dumb question |
| (:& | Angry |
| (:-& | Angry |
| (:-( | Unsmiley |
| (:-) | Smiley variation |
| (:-* | Kiss |
| (:-\ | Very sad |
| * | Kiss |
| [symbol] | Laughter |
| 8) | Wide-eyed, or wearing glasses |
| 8-) | Wide-eyed, or wearing glasses |
| 8-o | Shocked |
| 8-O | Astonished |
| 8-P | Yuck! |
| 8-[ | Frayed nerves; overwrought |
| 8-] | Wow! |
| 8-\| | Wide-eyed surprise |
| :( | Sad |
| :) | Smile |
| :[ | Bored, sad |
| :\| | Bored, sad |
| :( ) | Loudmouth, talks all the time; or shouting |
| :* | Kiss |
| :**: | Returning kiss |
| :,( | Crying |
| :-> | Smile of happiness or sarcasm |
| :->< | Puckered up to kiss |
| :-< | Very sad |
| :-( | Frown |
| :-) | Classic smiley |
| :-* | Kiss |
| :-, | Smirk |
| :-/ | Wry face |
| :-6 | Exhausted |
| :-9 | Licking lips |
| :-? | Licking lips, or tongue in cheek |
| :-@ | Screaming |
| :-C | Astonished |
| :-c | Very unhappy |
| :-D | Laughing |
| :-d˜ | Heavy smoker |
| :-e | Disappointed |
| :-f | Sticking out tongue |
| :-I | Pondering, or impartial |
| :-i | Wry smile or half-smile |
| :-j | One-sided smile |
| :-k | Puzzlement |
| :-l | One-sided smile |
| :-O | Open-mouthed, surprised |
| :-o | Surprised look, or yawn |
| :-P | Sticking out tongue |
| :-p | Sticking tongue out |
| :-Q | Tongue hanging out in disgust, or a smoker |
| :-Q˜ | Smoking |
| :-r | Sticking tongue out |
| :-s | What?! |
| :-t | Unsmiley |
| :-V | Shouting |
| :-X | My lips are sealed; or a kiss |
| :-x | Kiss, or My lips are sealed |
| :-Y | Aside comment |
| :-[ | Unsmiling blockhead; also criticism |
| :-\′\| | Sniffles |
| :-] | Smiling blockhead; also sarcasm |
| :-{) | Smile with moustache |
| :-{)} | Smile with moustache and beard |
| :-{} | Blowing a kiss |
| :-\| | Indifferent, bored or disgusted |
| :-∥ | Very angry |
| :-} | Mischievous smile |
| :.( | Crying |
| :C | Astonished |
| :e | Disappointed |
| :P | Sticking out tongue |
| ;) | Wink |
| ;-) | Winkey |
| \hat{ } \hat{ } \hat{ } | Giggles |
| \grave{ }:-) | Raised eyebrow |
| \|-<> | Puckered up for a kiss |
| \|-D | Big laugh |
| \|-O | Yawn |
| \|I | Asleep |
| \|\hat{ }o | Snoring |
| }-) | Wry smile |
| }:[ | Angry, frustrated |
| ˜:-( | Steaming mad |

What is claimed is:

1. A visual speech system, wherein the visual speech system comprises:
a data import system for receiving text data that includes word strings and emoticon strings; and
a text-to-animation system for generating a displayable animated face image that can reproduce facial movements corresponding to the received word strings and the received emoticon strings.

2. The visual speech system of claim 1, further comprising a keyboard for typing in text data.

3. The visual speech system of claim 1, further comprising a text-to-audio system that can generate an audio speech broadcast corresponding the received word strings.

4. The visual speech system of claim 3, further comprising an audio-visual interface for displaying the display able animated face image along with the audio speech broadcast.

5. The visual speech system of claim 1, wherein the text-to-animation system associates each emoticon string with an expressed emotion, and wherein the expressed emotion is reproduced on the animated face image with at least one facial movement.

6. The visual speech system of claim 5, wherein the text-to-animation system associates each word string with a spoken word, and wherein the spoken word is reproduced on the animated face image with at least one mouth movement.

7. The visual speech system of claim 6, wherein the at least one facial movement is morphed with the at least one mouth movement.

8. The visual speech system of claim 1, further comprising an input/output system for receiving and sending text data over a network.

9. A program product stored on a recordable medium, which when executed provides a visual speech system, comprising:
a data import system for receiving text data that includes word strings and emoticon strings; and
a text-to-animation system for generating a displayable animated face image that can reproduce facial movements corresponding to the received word strings and the received emoticon strings.

10. The program product of claim 9, wherein an inputted emoticon string is reproduced on the animated face image as an expressed emotion.

11. The program product of claim 10, wherein an inputted word string is reproduced on the animated face image by mouth movements.

12. The program product of claim 11, wherein the expressed emotion is morphed with the mouth movements.

13. An online chat system having visual speech capabilities, comprising:
a first networked client having:
a first data import system for receiving text data that includes word strings and emoticon strings; and
a data ex(port system for sending the text data to a network; and
a second networked client having:
a second data import system for receiving the text data from the network; and
a text-to-animation system for generating a displayable animated face image that reproduces facial movements corresponding to the received word strings and the received emoticon strings contained in the text data.

14. The online chat system of claim 13, wherein each emoticon string is reproduced on the animated face image as an expressed emotion.

15. The online chat system of claim 14, wherein each word string is reproduced on the animated face image by mouth movements.

16. The online chat system of claim 15, wherein the expressed emotion is morphed with the mouth movements.

17. A method of performing visual speech on a system having a displayable animated face image, comprising the steps of:
entering text data into a keyboard, wherein the text data includes word strings and emoticon strings;
converting the word strings to audio speech;
converting the word strings to mouth movements on the displayable animated face image, such that the mouth movements correspond with the audio speech;
converting the emoticon strings to facial movements on the displayable animated face image, such that the facial movements correspond with expressed emotions associated with the entered emoticon strings; and
displaying the animated face image along with a broadcast of the audio speech.

18. The method of claim 17, wherein the mouth movements and facial movements are morphed together.

19. The method of claim 17, wherein the displaying of the animated face image along with the broadcast of the audio speech is done remotely over a network.

20. A visual speech system, comprising:
a data import system for receiving text data that includes at least one emoticon string, wherein the at least one emoticon string is associated with a predetermined facial expression; and
a text-to-animation system for generating a displayable animated face image that can simulate at least one facial movement corresponding to the predetermined facial expression.
